(19) United States
(12) Patent Application Publication
(10) Pub. No.: US 2016/0209063 A1
(43) Pub. Date: Jul. 21, 2016

(54) ENVIRONMENT CONTROL METHOD, CONTROL APPARATUS AND POWER MANAGEMENT SYSTEM

(71) Applicant: MITAC INTERNATIONAL CORP., Taoyuan (TW)

(72) Inventor: Yi-Tse FANG, Guishan Township (TW)

(21) Appl. No.: 14/869,929

(22) Filed: Sep. 29, 2015

(30) Foreign Application Priority Data
Jan. 20, 2015 (TW) 104101857

(51) Int. Cl. F24F 11/00; G05B 15/02

(52) U.S. Cl. CPC F24F 11/006; F24F 11/0012; F24F 11/0015; F24F 11/0017; G05B 15/02; F24F 2011/0026; F24F 2011/0047; F24F 2011/0063; F24F 2011/0064; F24F 2011/0068; F24F 2011/0075

(57) ABSTRACT

An environment control method, an environment control apparatus, and a power management system are disclosed. The environment control method includes the following steps. Generate scheduling control information for an air conditioner according to somatosensory data and environment condition data by a scheduling module. Record an operational condition of the air conditioner at a different time point to generate an operation history by a monitoring and statistics module. Determine by a management module whether an amount of operational conditions not matching the scheduling control information in the operation history is greater than a first threshold during a time period. Execute a first adjustment process by the management module in order to adjust the scheduling control information when the amount of operational conditions not matching the scheduling control information in the operation history is greater than the first threshold during the time period.

### CROSS-REFERENCE TO RELATED APPLICATIONS

This non-provisional application claims priority under 35 U.S.C. §119(a) on Patent Application No(s). 104101857 filed in Taiwan, R.O.C. on Jan. 20, 2015, the entire contents of which are hereby incorporated by reference.

### TECHNICAL FIELD

The disclosure relates to an environment control technology, more particularly to an environment control method, control apparatus and power management system for adaptively adjusting schedule control information.

### BACKGROUND

Over the years population explosion has led to an energy crisis around the world. Many governments have been striving to solve the energy crisis because the crisis greatly alters human life and intensely affects economic activities around the world, and even may lead to a war when some countries vie with each other for energy resources.

So far energy conservation is one of more efficient schemes to mitigate the crisis, but people also prefer to use a great deal of electronic products in their daily life in order to have a comfortable and convenient environment. Therefore, people have to efficiently monitor and control operational conditions of their electronic products in order to give consideration to both saving energy resources and maintaining a comfortable and convenient lifestyle. However, conventional manual ways to monitor electronic products in use seems to be uneconomic and cannot provide real-time services.

For example, most conventional energy conservation systems of air conditioners merely allow people to directly set them to one temperature. In other words, if people are feeling cold or hot, the people in the same room as the air conditioner can only manually adjust the temperature setting of the air conditioner. Manually adjusting the air conditioner not only is inconvenient for the users but also cannot automatically control the air temperature to fit their needs for a comfortable environment according to a present power consumption and a target power consumption.

### SUMMARY

According to one or more embodiments, the disclosure provides an environment control method. In an embodiment, the environment control method includes the following steps. Generate schedule control information of an application apparatus according to somatosensory data and environment condition data. Record operational conditions of the application apparatus at different time points to generate an operational history. Determine if an amount of operational conditions not matching the schedule control information in the operational history is greater than a first threshold during a time period. Execute a first adjustment process in order to adjust the schedule control information when the amount of operational conditions not matching the schedule control information is greater than the first threshold during the time period.

In another embodiment, the schedule control information is updated according to the operational conditions recorded in the operational history during the time period.

In another embodiment, a first control signal is generated according to the operational condition not matching the schedule control information, and is written into the schedule control information.

In another embodiment, a second control signal is generated according to a first fine-tuning parameter and the operational condition not matching the schedule control information and is written into the schedule control information, and the first fine-tuning parameter indicates an adjustment of temperature.

In another embodiment, the method further includes determining whether the amount of operational conditions not matching the scheduling control information in the operation history is less than a second threshold during the time period; and executing a second adjustment process in order to adjust the schedule control information when the amount of operational conditions not matching the scheduling control information in the operation history is less than the second threshold during the time period.

In another embodiment, a third control signal is generated according to a second fine-tuning parameter and the operational condition matching the schedule control information and is written into the schedule control information, and the second fine-tuning parameter indicates another adjustment of temperature.

In another embodiment, the first threshold and the second threshold are updated according to a present power consumption and a power consumption limitation.

In another embodiment, the first threshold and the second threshold are updated according to the environment condition data obtained from one or more temperature sensors or hygrometers or carbon dioxide meters.

According to one or more embodiments, the disclosure provides an environment control apparatus. In an embodiment, the environment control apparatus includes a scheduling module, a monitoring and statistics module, a contract capacity module, and a management module. The management module is coupled to the scheduling module, the monitoring and statistics module and the contract capacity module. The scheduling module generates schedule control information for an application apparatus according to a piece of somatosensory data and a piece of environment condition data. The monitoring and statistics module records an operational condition of the application apparatus at a different time point to generate an operational history. The contract capacity module generates a first threshold. The management module determines whether an amount of operational conditions not matching the schedule control information in the operational history is greater than the first threshold during a time period. When the amount of operational conditions not matching the schedule control information in the operational history is greater than the first threshold during the time period, the management module executes a first adjustment process in order to adjust the schedule control information.

According to one or more embodiments, the disclosure provides a power management system. In an embodiment, the power management system includes an environment control apparatus, an air conditioner, a coordinator, a main host, an energy management host, and a terminal apparatus. The environment control apparatus includes at least one sensor, at least one electric meter, and a first wireless node device. The sensor senses a condition of a real environment. The electric meter measures electrical information. The first wireless node device receives the sensing result from the sensor and the measurement result from the electric meter. The air conditioner includes at least one frequency converter, a programmable logic controller, and a second wireless node device. The coordinator receives information from the first wireless node device and the second wireless node device and controls the first wireless node device and the second wireless node device. The main host receives information from the coordinator and controls the coordinator. The energy management host analyzes statistics of information received from the main host and commands the main host according to the analysis result. The main host manages the environment detection apparatus or the air conditioner through the coordinator. The terminal apparatus receives information from the main host and the energy management host and shows it on a screen.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a block diagram of an environment control apparatus according to an embodiment of the disclosure;

FIG. 2 is a system structure diagram of a power management system according to an embodiment of the disclosure; and

FIG. 3 is a flow chart of an environment control method according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

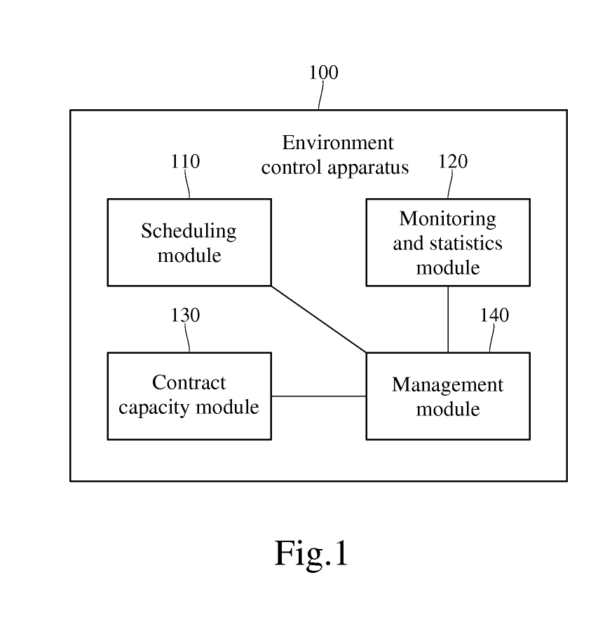

FIG. 1 is a block diagram of an environment control apparatus 100 according to an embodiment of the disclosure. The environment control apparatus 100 includes a scheduling module 110, a monitoring and statistics module 120, a contract capacity module 130, and a management module 140. The management module 140 is coupled to the scheduling module 110, the monitoring and statistics module 120, and the contract capacity module 130. The environment control apparatus 100 is, for example but not limited to, a desktop computer, a notebook, or a smart electronic device. The scheduling module 110, the monitoring and statistics module 120, the contract capacity module 130 and the management module 140 can be carried out by, for example, a variety of functional chips or microprocessors.

The scheduling module 110, according to somatosensory data and environment condition data, produces schedule control information for apparatuses. For example, the environment condition data refers to the humidity, the concentration of carbon dioxide (CO₂), or other environment condition indicators. The environment condition data is obtained from, for example, unlimited to one or more temperature sensors or hygrometers or carbon dioxide meters. For example, the somatosensory data is about air temperatures or other environment conditions the human body senses. Such apparatuses include one or more illumination apparatuses, one or more air conditioners, one or more power suppliers, one or more communication apparatuses or one or more other surrounding application apparatuses.

To clearly illustrate the disclosure, the following embodiments will be described based on an air conditioner in a conference room as such an application apparatus. The schedule control information corresponds to a control signal to arrange a preset temperature to set the air conditioner in the conference room. The scheduling module 110 estimates the schedule control information of the air conditioner for users in the conference room by a certain algorithm.

The monitoring and statistics module 120 records a plurality of operational conditions of the air condition at various time points to produce an operational history. The operational history corresponds to the records of the actual last-week operation of the application apparatus produced, and the recording period is, for example but not limited to, 3 days, 1 month, or a half of a year. For example, the operational history generated by the monitoring and statistics module 120 recites information indicating that the air conditioner actually operated at a temperature of 24 degrees last Monday and at a temperature of 25 degrees last Tuesday.

The contract capacity module 130 generates a first threshold and a second threshold. The first threshold herein is a basis for the environment control apparatus 100 to commence to execute a first adjustment process in order to adjust the schedule control information, so that the environment control apparatus 100 adjusts the operation of the application apparatus to fit the user's actual preference in usage. The second threshold herein is a basis for the environment control apparatus 100 to commence to execute a second adjustment process in order to adjust the schedule control information so that the environment control apparatus 100 can tune the operation of the air conditioner under the user's acceptable range in order to conserve energy. This will be illustrated in detail as follows.

The management module 140 determines if an amount of operational conditions of the application apparatus not matching the corresponding schedule control information in the operational history is greater than the first threshold during a certain time period. The certain time period is, for example but not limited to, one week. The first threshold is, for example but not limited to, four days in a week. When such an amount is greater than the first threshold, the environment control apparatus 100 begins to execute the first adjustment process in order to adjust the schedule control information.

In an example, assume that in the schedule control information the air conditioner is preset to operate at a temperature of 26 degrees on Monday, at a temperature of 27 degrees on Tuesday, at a temperature of 25 degrees on Wednesday, at a temperature of 25 on Thursday, at a temperature of 28 degrees on Friday, at a temperature of 26 degrees on Saturday, and at a temperature of 27 degrees on Sunday. Also, the operational history of the air conditioner recites that the air conditioner actually operated at a temperature of 24 degrees (i.e. the operational condition 1) last Monday, at a temperature of 25 degrees (i.e. the operational condition 2) last Tuesday, at a temperature of 22 degrees (i.e. the operational condition 3) last Wednesday, at a temperature of 24 degrees (i.e. the operational condition 4) last Thursday, at a temperature of 26 degrees (i.e. the operational condition 5) last Friday, at a temperature of 26 degrees (i.e. the operational condition 6) last Saturday, and at a temperature of 27 degrees (i.e. the operational condition 7) last Sunday. In this case, there are 5 operation conditions of the air conditioner (i.e. the operation conditions of the air conditioner collected from last Monday to Friday) not matching the schedule control information, and such an amount is greater than the first threshold (i.e. 4 days/week). In other words, the schedule control information herein does not match the user's actual preference in usage. Then, the management module 140 commences to execute the first adjustment process, where the management module 140 updates the schedule control information according to the operational conditions of the air conditioner recorded in the operational history during the certain time period.

Under the first adjustment process, the management module 140 generates a first control signal according to the operational conditions not matching the schedule control information, and writes the first control signal into the schedule control information. In an example following the above example of the operational conditions 1 to 5 not matching the schedule control information, the management module 140 renews the setting of temperature for the time points of the above operational conditions 1 to 5 not matching the schedule control information, to generate the first control signal and updates the schedule control information. In this way, a new temperature setting for the air conditioner may fit the user's preference much more for the next week.

In another embodiment, the management module 140 under the first adjustment process generates a second control signal according to the operational condition not matching the schedule control information, and a first fine-tuning parameter and writes the second control signal into the schedule control information. The first fine-tuning parameter indicates an adjustment of temperature. For example, when the operational conditions 1 to 5 do not match the schedule control information and the first fine-tuning parameter is 1 degree, the management module 140 decreases a preset operational temperature of the air conditioner for the next Monday to Friday by 1 degree in the schedule control information to generate the second control signal corresponding to the first fine-tuning, where next operational temperatures to set the air conditioner from Monday to Friday are 25, 26, 24, 24 and 27 degrees, respectively. Accordingly, a temperature setting for the air conditioner may progressively fit the user's preference in usage in the feature.

On the other hand, since the contract capacity module 130 generates the second threshold, the management module 140 also determines whether or not an amount of operational conditions of the air conditioner not matching the schedule control information in the operational history is less than the second threshold during the above certain time period. When such an amount is less than the second threshold, the environment control apparatus 100 begins to execute the second adjustment process in order to adjust the schedule control information.

In an example, the schedule control information presets that the air conditioner operates at a temperature of 26 degrees on Monday, at a temperature of 27 degrees on Tuesday, at a temperature of 25 degrees on Wednesday, at a temperature of 25 degrees on Thursday, at a temperature of 28 degrees on Friday, at a temperature of 28 degrees on Saturday, and at a temperature of 25 degrees on Sunday, and however, the operational history recites that the air conditioner actually operates at a temperature of 26 degrees (i.e. an operational condition 8) on Monday, at a temperature of 27 degrees (i.e. an operational condition 9) on Tuesday, at a temperature of 22 degrees (i.e. an operational condition 10) on Wednesday, at a temperature of 25 degrees (i.e. an operational condition 11) on Thursday, at a temperature of 28 degrees (i.e. an operational condition 12) on Friday, at a temperature of 28 degrees (i.e. an operational condition 13) on Saturday, and at a temperature of 25 degrees (i.e. an operational condition 14) on Sunday. In this case, the amount of operational conditions not matching the schedule control information is 1, that is, the operational condition on Wednesday does not match the schedule control information. If the second threshold in this case is 2 (day/week), the amount of operational conditions not matching the schedule control information, i.e. 1, is less than the second threshold, i.e. 2 (day/week). This means that the present schedule control information has almost fit the user's preference in usage. Therefore, the management module 140 can commence to execute the second adjustment process in order to adjust the schedule control information for energy conservation.

In the second adjustment process, the management module 140 generates a third control signal according to a second fine-tuning parameter and the one or more operational conditions matching the schedule control information and writes the third control signal into the schedule control information. The second fine-tuning parameter indicates an adjustment of temperature. In an example following the above example of the operational condition not matching the schedule control information on Wednesday, if the second fine-tuning parameter is 0.5 degree, the management module 140 increases, by 0.5 degree, the temperatures of the operational conditions 8, 9, 11, 12, 13, 14 (i.e. 26, 27, 25, 28, 28, and 25 degrees) matching the schedule control information, to generate a third control signal for the schedule control information, where the temperatures of the operational conditions are updated to be 26.5, 27.5, 25.5, 28.5, 28.5 and 25.5 degrees, respectively after the second fine-tuning is performed. In this way, the environment control apparatus 100 will progressively tune the operation of the air conditioner under the user's acceptable range in the feature in order to conserve energy.

In another embodiment, the contract capacity module 130 updates the first threshold and the second threshold according to a present power consumption and a power consumption limitation. For example, if the present power consumption compared with the power consumption limitation is still sufficient enough to be used, the contract capacity module 130 decreases the first threshold and increases the second threshold; otherwise, the contract capacity module 130 increases the first threshold and decreases the second threshold.

In another embodiment, the contract capacity module 130 updates the first threshold and the second threshold according to the environment condition data. For example, when the humidity or the concentration of carbon dioxide in a conference room is higher than an average value, the contract capacity module 130 decreases the first threshold and increases the second threshold.

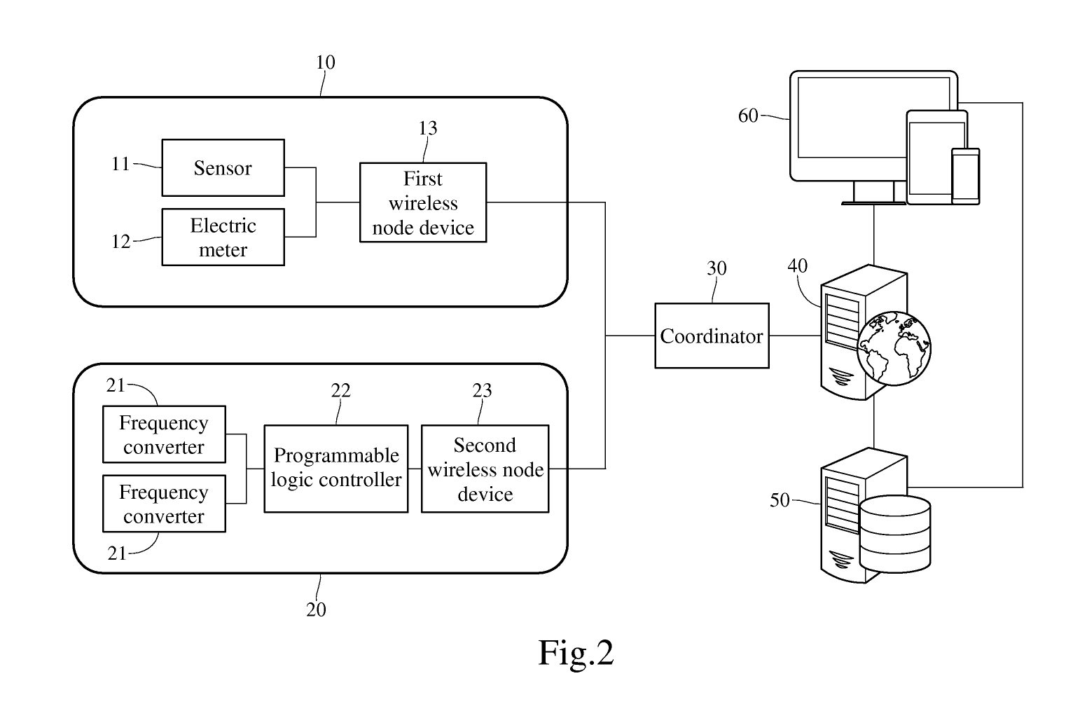

FIG. 2 is a system structure diagram of a power management system according to an embodiment of the disclosure. An environment detection apparatus 10 includes one or more sensors 11, one or more electric meters 12, and a first wireless node device 13. The sensor 11 senses a real environment and sends the sensing result to the first wireless node device 13. The electric meter 12 senses a signal of electronic information to the first wireless node device 13.

An air conditioner 20 includes one or more frequency converters 21, a programmable logic controller (PLC) 22, and a second wireless node device 23. A coordinator 30 receives signals sent by the first wireless node device 13 and the second wireless node device 23. The coordinator 30 communicates with the first wireless node device 13 and the second wireless node device 23 by a wireless communication technology. The coordinator 30 employs the first wireless node device 13 and the second wireless node device 23 to command the sensor 11, the electric meter 12, the frequency converter 21 or the programmable logic controller 22, for example, inquiring real-time readings or editing settings.

A main host 40 receives signals from the coordinator 30 and commands the coordinator 30. An energy management host 50 compiles and analyzes statistics of data sent by the main host 40 and then commands the main host 40 according to the analysis result. The main host 40 employs the coordinator 30 to manage the environment detection apparatus 10 or the air conditioner 20. A terminal apparatus 60 receives the first information from the main host 40 and the second information from the energy management host 50 and shows them on a screen. The first information herein is a real-time reading of the sensor, the electric meter or the programmable logic controller, and the second information herein is the computed environment condition information or power consumption information.

The main host 40 reads present environment condition information (e.g. the temperature/humidity/CO₂ concentration sensed by the sensor 11 and/or the present power consumption measured by the electric meter 12) from the environment detection apparatus 10 and present operational condition information from the air conditioner 20 and sends them to the energy management host 50 and the terminal apparatus 60.

The energy management host 50 processes and analyzes the information sent by the main host 40 to obtain so-called somatosensory data and so-called environment condition data and generates such schedule control information according to the somatosensory data and so-called environment condition data. Then, the energy management host 50 records a plurality of operational conditions of the air conditioner 20 detected by, for example, the sensor 11, the electric meter 12, the frequency converter 21 or the programmable logic controller 22 at different time points to establish an operational history. Further, the energy management host 50 determines whether or not an amount of operational conditions not matching the schedule control information in the operational history is greater than the above first threshold during a certain time period.

In the operational history, when an amount of operational conditions of the air conditioner 20 not matching the schedule control information is greater than the first threshold during the certain time period, the system commences to execute the first adjustment process in order to adjust the schedule control information. In the first adjustment process, an administrator can set the power consumption limitation for the main host 40 by a setting interface provided by the terminal apparatus 60. Also, the electric meter 12 reads the present power consumption, and the sensor 11 reads the environment condition data.

In an embodiment, the first or second fine-tuning parameter can manually be set by such a setting interface provided by the terminal apparatus 60 operated by the administrator. In another embodiment, the first or second fine-tuning parameter can automatically be set according to the power consumption limitation by the energy management host 50. In an example, when sensing that the present power consumption approaches the power consumption limitation, the energy management host 50 reduces the first fine-tuning parameter and increases the second fine-tuning parameter. Therefore, the automatic decrease of the temperature to set the air conditioner 20 slows down and the automatic increase of the temperature to set the air conditioner 20 speeds up. In this way, the first or second threshold can adaptively be adjusted according to the present power consumption, the power consumption limitation and the environment condition data by the energy management host 50, and alternatively, the first or second threshold can manually be adjusted by the terminal apparatus 60 that the administrator actively operates according to his/her needs.

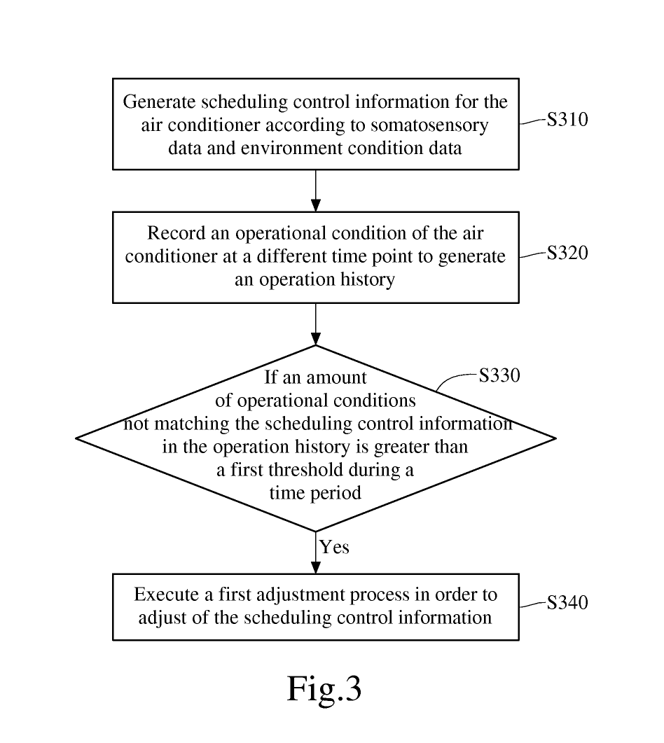

The above operation of the system is summarized in an environment control method, as shown in FIG. 3.

In step S310, the scheduling module 110 generates schedule control information for an application apparatus according to the somatosensory data and the environment condition data. In step S320, the monitoring and statistics module 120 records a plurality of operational conditions of the application apparatus at a plurality of time points to establish an operational history. In step S330, the management module 140 determines whether or not an amount of operational conditions not matching the schedule control information in the operational history is greater than the first threshold generated by the contract capacity module 130 during the certain time period. In step S340, when such an amount is greater than the first threshold, the management module 140 commences to execute the first adjustment process in order to adjust the schedule control information. These steps have been illustrated in detail by the above embodiments and thus, will not be repeated hereinafter.

In view of the above description, the disclosure pounders the present power consumption, the power consumption limitation, or the environment condition data in order to update the first threshold and the second threshold. Also, the disclosure compares the schedule control information with the operational history. When the amount of operational conditions of the application apparatus, not matching the schedule control information, is greater than the first threshold, the system commences to execute the first adjustment process in order to adjust the schedule control information, so as to control the application apparatus's operation to fit the user's preference in usage. When the amount of operational conditions of the application apparatus, not matching the schedule control information, is less than the second threshold, the system commences to execute the second adjustment process used for adjusting the schedule control information to tune the operation of the application apparatus under the user's acceptable range, thereby conserving energy resources.

What is claimed is:

1. A power conservation method for an air conditioner, comprising:
generating scheduling control information for the air conditioner according to somatosensory data and environment condition data by a scheduling module;
recording an operational condition of the air conditioner at a different time point to generate an operation history by a monitoring and statistics module;
determining by a management module whether an amount of operational conditions not matching the scheduling control information in the operation history is greater than a first threshold during a time period; and
executing a first adjustment process by the management module in order to adjust the scheduling control information when the amount of operational conditions not matching the scheduling control information in the operation history is greater than the first threshold during the time period.

2. The power conservation method according to claim 1, wherein the first adjustment process comprises:
updating the scheduling control information according to the operational conditions of the air conditioner recorded during the time period in the operation history by the management module.

3. The power conservation method according to claim 2, wherein the step of updating the scheduling control information according to the operational conditions of the air conditioner recorded during the time period in the operation history comprises:
generating a first control signal by the management module according to the operational condition not matching the scheduling control information; and
writing the first control signal into the scheduling control information by the management module.

4. The power conservation method according to claim 2, wherein the step of updating the scheduling control information according to the operational conditions of the air conditioner recorded during the time period in the operation history comprises:
generating a second control signal by the management module according to a first fine-tuning parameter and the operational condition not matching the scheduling control information, the first fine-tuning parameter indicates an adjustment of temperature; and
writing the second control signal into the scheduling control information by the management module.

5. The power conservation method according to claim 4, further comprising:
determining by the management module whether the amount of operational conditions not matching the scheduling control information in the operation history is less than a second threshold during the time period; and
executing a second adjustment process by the management module in order to adjust the scheduling control information when the amount of operational conditions not matching the scheduling control information in the operation history is less than the second threshold during the time period.

6. The power conservation method according to claim 5, wherein the step of executing the second adjustment process comprises:
generating a third control signal by the management module according to a second fine-tuning parameter and the operational condition matching the scheduling control information, wherein the second fine-tuning parameter indicates an adjustment of temperature; and
writing the third control signal into the scheduling control information by the management module.

7. The power conservation method according to claim 6, further comprising:
updating the first threshold and the second threshold according to a present power consumption and a power consumption limitation by a contract capacity module.

8. The power conservation method according to claim 7, further comprising:
updating the first threshold and the second threshold according to the environment condition data by the contract capacity module, wherein the environment condition data obtained from one or more temperature sensors or hygrometers or carbon dioxide meters.

9. A control apparatus for power conservation during air conditioning, comprising:
a scheduling module, for generating scheduling control information of an air conditioner according to somatosensory data and environment condition data;
a monitoring and statistics module, for recording a plurality of operational conditions of an air conditioner at different time points to generate an operation history;
a contract capacity module, for generating a first threshold; and
a management module coupled to the scheduling module, the monitoring and statistics module and the contract capacity module, for determining whether an amount of operational conditions of the air conditioner not matching the scheduling control information in the operation history is greater than the first threshold during a time period, and for executing a first adjustment process in order to adjust the scheduling control information when the amount of operational conditions is greater than the first threshold.

10. The control apparatus according to claim 9, wherein the management module further updates the scheduling control information according to the operational conditions recorded during the time period in the operation history.

11. The control apparatus according to claim 10, wherein the management module further generates a first control signal according to the operational condition not matching the scheduling control information, and writes the first control signal into the scheduling control information.

12. The control apparatus according to claim 11, wherein the management module further generates a second control signal according to a first fine-tuning parameter and the operational condition not matching the scheduling control information, and writes the second control signal into the scheduling control information, and the first fine-tuning parameter indicates an adjustment of temperature.

13. The control apparatus according to claim 12, wherein the contract capacity module further generates a second threshold, the management module further determines whether the amount of operational conditions recorded in the time period and not matching the scheduling control information in the operation history is less than the second threshold, and when the amount of operational conditions recorded in the time period and not matching the scheduling control information in the operation history is less than the second threshold, the management module executes a second adjustment process in order to adjust the scheduling control information.

14. The control apparatus according to claim 13, wherein the management module further generates a third control signal according to a second fine-tuning parameter and the operational condition matching the scheduling control information, and writes the third control signal into the scheduling control information in the second adjustment process, and the second fine-tuning parameter indicates another adjustment of temperature.

15. The control apparatus according to claim 14, wherein the contract capacity module further updates the first threshold and the second threshold according to a present power consumption and a power consumption limitation.

16. The control apparatus according to claim 15, wherein the contract capacity module further updates the first threshold and the second threshold according to the environment condition data obtained from one or more temperature sensors or hygrometers or carbon dioxide meters.

17. A power management system, comprising:
an environment detection apparatus comprising at least one sensor for sensing a real environment, at least one electric meter for measuring electrical information, and a first wireless node device for receiving the sensing result from the sensor and the measurement result from the electric meter;
an air conditioner, comprising at least one frequency converter, a programmable logic controller, and a second wireless node device;
a coordinator, for receiving signals from the first wireless node device and the second wireless node device;
a main host, for receiving signals from the coordinator;
an energy management host, for analyzing statistics of the signals received from the main host, and commanding the main host according to analysis result, so that the main host manages the energy management host or the air conditioner through the coordinator; and
a terminal device, for receiving first information from the main host and second information from the energy management host and displaying them on a screen;
wherein the first information is a real-time reading of the sensor, the electric meter or the programmable logic controller, and the second information is environment information or power consumption information computed.

18. The power management system according to claim 17, wherein the energy management host generates scheduling control information of the air conditioner according to somatosensory data and environment condition data, and the environment condition data is obtained from one or more temperature sensors or hygrometers or carbon dioxide meters;
the energy management host records operational conditions of the air conditioner at different time points to generate an operation history;
the energy management host determines whether an amount of operational conditions of the air conditioner not matching the scheduling control information in the operation history is greater than a first threshold during a time period; and
when the amount of operational conditions of the air conditioner not matching the scheduling control information in the operation history is greater than the first threshold during the time period, the energy management host executes a first adjustment process to update the scheduling control information.
